(19) United States
(12) Patent Application Publication
(10) Pub. No.: US 2014/0001760 A1
(43) Pub. Date: Jan. 2, 2014

(54) WIND-POWERED AUTOMOTIVE ELECTRIC GENERATOR

(71) Applicant: Alexander Michael Hembree, Cordova, MD (US)

(72) Inventor: Alexander Michael Hembree, Cordova, MD (US)

(21) Appl. No.: 13/540,578

(22) Filed: Jul. 2, 2012

(51) Int. Cl. H02K 7/18

(52) U.S. Cl. 290/52

(57) ABSTRACT

A system harnesses the wind generated by an automobile and uses it to supply a steady electrical current to either fully power the vehicle, or at least reduce its inefficiency. The system of the present invention balances efficiency and aesthetics to enable electrical power to be generated within the vehicle either to be consumed by an electric motor, or to be stored for later use. With increased development of electric vehicles, the system of the present invention may be particularly useful to extend the range of these vehicles, alleviating a considerable drawback of such vehicles.

### BACKGROUND OF THE INVENTION

The present invention relates to electric generators and, more particularly, to a wind-powered automotive electric generator.

To reduce dependence on foreign oil and improve air quality with reduced emissions, an increased number of electric car models are coming out on the market. One important limitation of these models is that they typically have shortened ranges, requiring an electric recharge frequently, which can take considerable time.

Attempts have been made to generate electricity to power vehicles. However, several problems exist with these models. Efficient models are designed in a manner that is unattractive, whereas the attractive models are either designed inefficiently or have suffered design flaws that prevented their general use. For example, some models attempt to downplay the wind generator portion of the vehicle in favor of charging stations. Other models were constructed in a way as to completely forego appearance for the sake of efficiency. This unfortunate circumstance has caused a total lack of acceptance of this technology in the marketplace and results in a situation in which one would guess that no technological advancements were made at all.

As can be seen, there is a need for a wind-powered automotive electric generator system that is both efficient and aesthetically pleasing.

### SUMMARY OF THE INVENTION

In one aspect of the present invention, a wind-powered automotive electric generator comprises one or more hood air-mouth entrances formed into the hood of a car; a tunnel extending from each of the hood air mouth entrances; a turbine disposed in each of the tunnels; one or more gearboxes driven by the turbine, the gearboxes disposed outside of the tunnel; and one or more generators driven by an output from the one or more gearboxes, wherein the tunnel is designed with a cross-sectional area that decreases from the hood air mouth entrance to its opposite end.

In another aspect of the present invention, an electric motor driven vehicle, comprises a vehicle hood; one or more hood air mouth entrances formed into the hood of the vehicle; a tunnel extending from each of the hood air mouth entrances; a turbine disposed in each of the tunnels; one or more gearboxes driven by the turbine, the gearboxes disposed outside of the tunnel; and one or more generators driven by an output from the one or more gearboxes, wherein the tunnel is designed with a cross-sectional area that decreases from the hood air mouth entrance to its opposite end.

These and other features, aspects and advantages of the present invention will become better understood with reference to the following drawings, description and claims.

### BRIEF DESCRIPTION OF THE DRAWINGS

FIG. 1 is a perspective view of a car having a wind-powered electric generator according to an exemplary embodiment of the present invention;

FIG. 2 is a perspective view of an entrance for a hood air intake of a car having a wind-powered electric generator according to an exemplary embodiment of the present invention;

FIG. 3 is a partial cross-sectional side view of an air intake tunnel with its associated turbine, gear box and generator, according to an exemplary embodiment of the present invention;

FIG. 4 is a perspective view of a turbine with adjustable blades according to an exemplary embodiment of the present invention;

FIG. 5 is a perspective view of a turbine with fixed blades according to an exemplary embodiment of the present invention;

FIG. 6 is a perspective view of a car having a wind-powered electric generator according to an exemplary embodiment of the present invention;

FIGS. 7 through 10 indicate that the factors of size, position, number, type, shape, and aerodynamic structure of the system(s), among other properties, are able to be interpreted without interfering with the validity or intended design of the main idea summarized in FIG. 1;

FIG. 11 is a partially cut-away view of an air intake showing a turbine disposed therewithin;

FIG. 12 is a detailed view of the air intake of FIG. 11;

FIGS. 13 through 16 show a nozzle assembly having a variable air intake according to an exemplary embodiment of the present invention;

FIG. 17 shows an intake iris adjusted to a narrow opening, according to an exemplary embodiment of the present invention; and

FIG. 18 shows the intake iris of FIG. 17, adjusted to a wider opening.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system to harness the wind generated by an automobile and using it to supply a steady electrical current to either fully power the vehicle, or at least reduce its inefficiency. The system of the present invention balances efficiency and aesthetics to enable electrical power to be generated within the vehicle either to be consumed by an electric motor, or to be stored for later use. With increased development of electric vehicles, the system of the present invention may be particularly useful to extend the range of these vehicles, alleviating a considerable drawback of such vehicles.

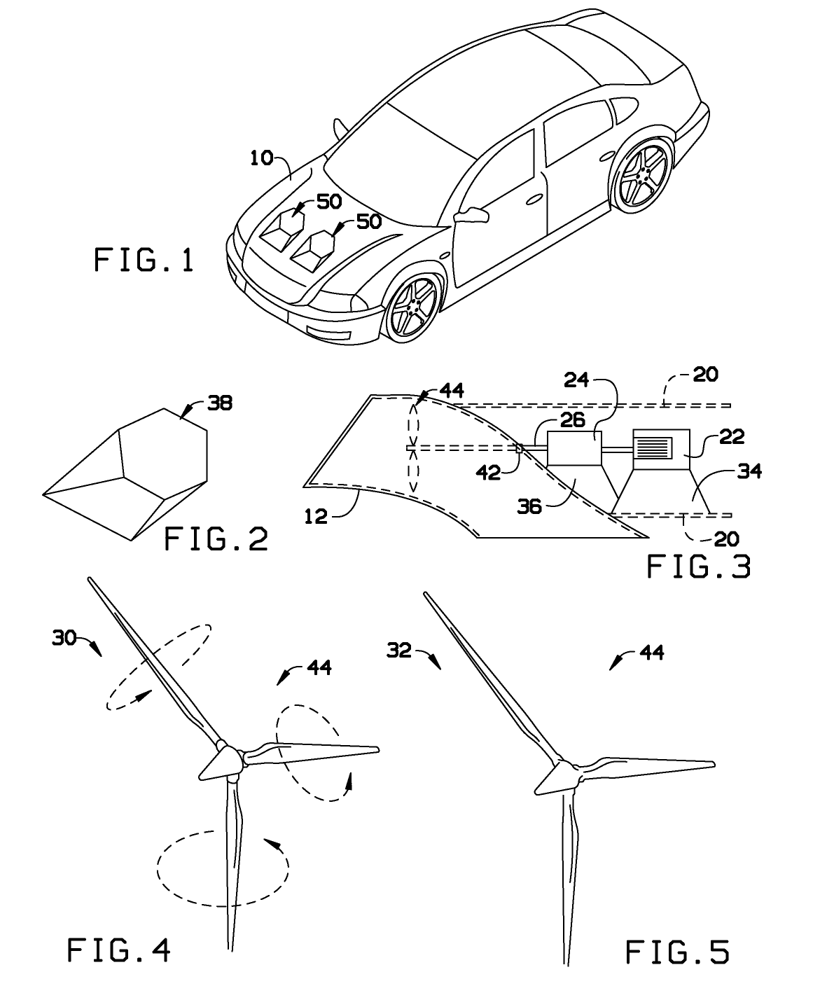

Referring to FIG. 1 through 3, a car 10 can be provided with one or more hood air mouth entrances 50 to permit air to flow through a tunnel 12. A turbine 44 can be disposed inside the tunnel 12 where air passing over the car 10 when the car 10 is in motion can turn the turbine 44. A tunnel/gear box shaft 26 can interconnect the turbine 44 to a gear box 24. The tunnel/gear box shaft 26 can extend from inside the tunnel 12, where the turbine 44 is disposed, to outside of the tunnel 12, where the gearbox 24 is disposed.

The gearbox 24 may connect, either directly or via a shaft, to turn a generator 22. The generator 22 may be disposed outside of the tunnel 12 and is typically mounted, via a generator platform 34, to a chassis model skeleton 20 of the car 10. Similarly, the gearbox 24 may be disposed outside of the tunnel 12 and is typically mounted, via a gearbox platform 36 to the chassis model skeleton 20. The generator 22 may be used to supply power to an electric motor (not shown) or may be used to store energy in one or more energy storage devices, such as batteries (not shown). Multiple shafts may be provided, or variable speed outputs can be provided from the gear box 24. For example, a gearbox output shaft may be provided for higher and lower wind speeds.

Referring to FIGS. 4 and 5, the turbine 44 can be designed in various configurations. Typically, the turbine 44 has a plurality of turbine blades, usually from about 3 to 5 blades. In some embodiments, the turbine 44 can be designed as a fixed blade turbine 32, where the angles of the turbine blades are fixed. In other embodiments, the turbine 44 can be designed as a variable blade turbine 30, where the angle of the turbine blades can vary. In this embodiment, the turbine blade angles may vary to help control the rotational speed of the turbine 44 to help prevent an overspeed condition for the generator, for example.

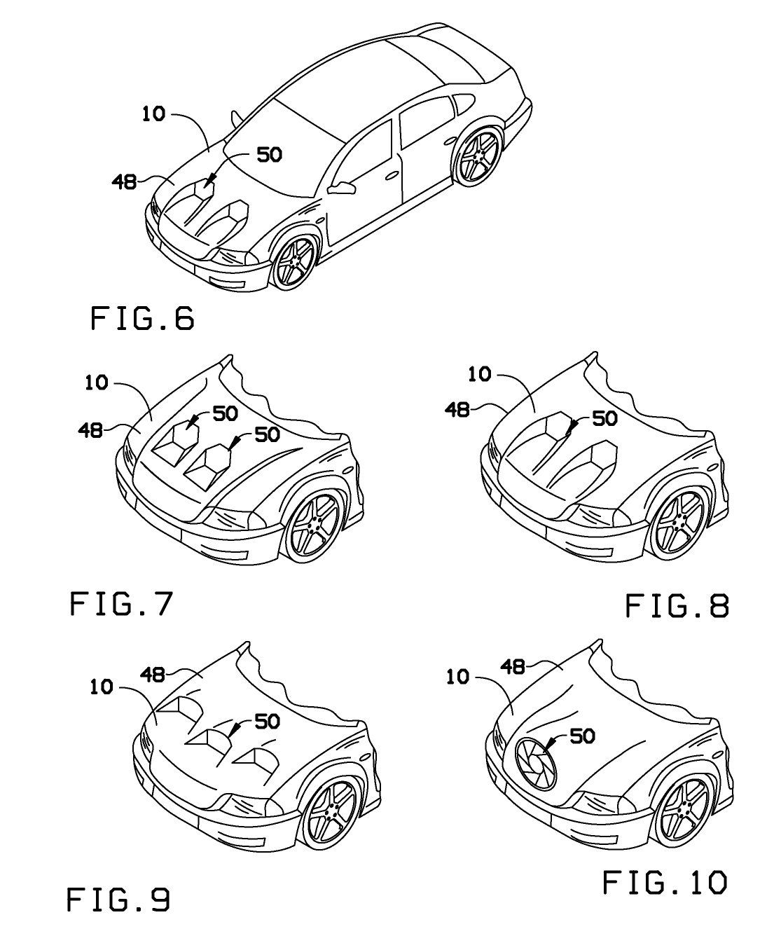

As shown in FIGS. 6 through 10, various designs of hood air mouth entrances 50 can be envisioned within the scope of the present invention. One or more of the hood air mouth entrances 50 can be formed in a hood 48 of the car 10 and sized accordingly to both size and power requirements. The hood air mouth entrances 50 can be of various shapes and sizes, provided that they can capture air flowing across the car 10 while it is in motion. Where multiple hood air mouth entrances 50 are used, the outputs can be either combined in a single gear box to feed a single generator, or a single gear box and generator can be used for each one of the hood air mouth entrances 50.

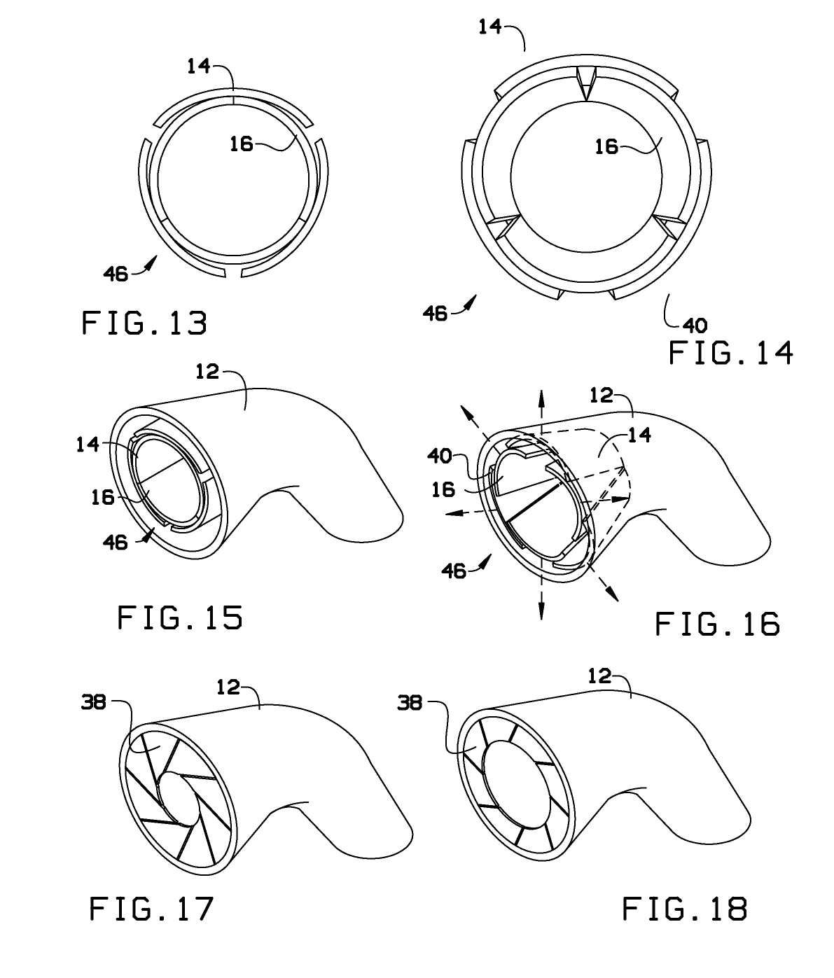

In some embodiments, as shown in FIGS. 13 through 16, a nozzle assembly 46 can be provided that adjusts the size of the air intake. In this embodiment, an outer shell nozzle piece 14 may move relative to an inner shell nozzle piece 16 to adjust the opening from a more narrow opening (FIG. 15) to a larger opening (FIG. 16), for example. This variable opening design can help control the rotation speed of the turbine 44.

In some embodiments, as shown in FIGS. 17 and 18, the tunnel 12 can be equipped with an intake iris 38 that may adjust the size of the air intake opening. The intake iris 38 may rotate to change its aperture to help control the rotation speed of the turbine 44.

In some embodiments, a disc brake 42 (see FIG. 3) can be provided to also help control the rotation speed of the turbine 44. If the speed increases beyond a speed desirable for the generator 22 or the gear box 24, the disc brake 42 can be applied to help slow the turbine 44.

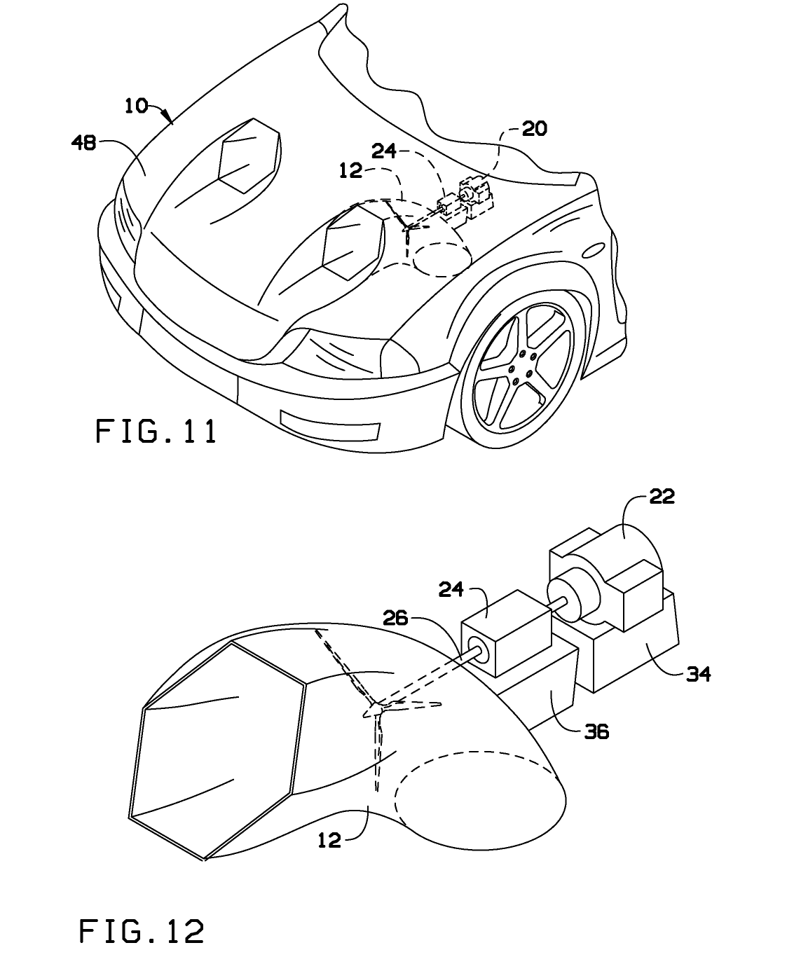

Referring now to FIGS. 11 and 12, regardless of the design of the hood air mouth entrance, the tunnel 12 is typically designed without abrupt curves, taking the intake air and expelling the air typically under the car 10. The tunnel 12 can be designed to create a phenomenon similar to the Venturi effect, where the cross-sectional area of the tunnel decreases from the hood air mouth entrance to the tunnel's exit.

Typically, the turbine 44 is disposed proximate to the hood air mouth entrance 50, where the turbine 44 can be turned by air before its direction is changed for discharge. However, in other embodiments, the turbine 44 can be mounted in various positions along the tunnel 12.

The heat produced by the generators, brakes, and the like, can be cooled by the circulation of wind generated by the car.

The system of the present invention can include various auxiliary systems and/or singular devices to maintain, enhance, or build upon the generating system described above. These auxiliary systems and/or singular devices can include, but are not limited to, the following examples: 1) A monitoring system to track heat, input, output, system efficiency, and other critical data; 2) An electronic structure to ensure mechanical coordination and system response; 3) Physical shields or grates to protect the tunnel during use or while it sits idle from the elements, flying debris, or other potential hazards to the patented system; and 4) Specialized equipment to gather data from GPS or other mapping mechanisms to allow for future route planning and energy preparation.

While the present invention is described above with respect to an electric car, embodiments of the present invention can be useful in both pure electric vehicles as well as hybrid vehicles, where electricity generation via wind energy can reduce the need for burning fuels in the internal combustion engine.

It should be understood, of course, that the foregoing relates to exemplary embodiments of the invention and that modifications may be made without departing from the spirit and scope of the invention as set forth in the following claims.

What is claimed is:

1. A wind-powered automotive electric generator comprising:
one or more hood air mouth entrances formed into a hood of a car;
a tunnel extending from each of the hood air mouth entrances;
a turbine disposed in each of the tunnels;
one or more gearboxes driven by the turbine, the gearboxes disposed outside of the tunnel; and
one or more generators driven by an output from the one or more gearboxes, wherein
the tunnel is designed with a cross-sectional area that decreases from the hood air mouth entrance to its opposite end.

2. The wind-powered automotive electric generator of claim 1, wherein the turbine is a fixed blade turbine.

3. The wind-powered automotive electric generator of claim 1, wherein the turbine is a variable blade turbine.

4. The wind-powered automotive electric generator of claim 1, further comprising a disc brake operable to slow a tunnel/gear box shaft.

5. The wind-powered automotive electric generator of claim 1, wherein the tunnel is equipped with mechanics to maintain a constant adjusting capacity to ensure optimum efficiency, a desired level of wind collection, and/or a closed state wherein wind has ceased to be collected.

6. The wind-powered automotive electric generator of claim 5, further comprising an outer shell nozzle piece and an inner shell nozzle piece, wherein the nozzle pieces are configurable to vary an opening to the tunnel.

7. The wind-powered automotive electric generator of claim 5, further comprising an intake iris configurable to vary an opening to the tunnel.

8. The wind-powered automotive electric generator of claim 1, further comprising a chassis model skeleton supporting the generator.

9. An electric motor driven vehicle comprising:
a vehicle hood;
one or more hood air mouth entrances formed into the hood of the vehicle;
a tunnel extending from each of the hood air mouth entrances;
a turbine disposed in each of the tunnels;
one or more gearboxes driven by the turbine, the gearboxes disposed outside of the tunnel; and
one or more generators driven by an output from the one or more gearboxes, wherein
the tunnel is designed with a cross-sectional area that decreases from the hood air mouth entrance to its opposite end.

10. The electric motor driven vehicle of claim 9, further comprising a chassis model skeleton disposed under the hood to support the generator.

11. The electric motor driven vehicle of claim 9, further comprising a generator platform supporting the generator on the chassis model skeleton.
